(19) United States
(12) Patent Application Publication
(10) Pub. No.: US 2011/0121592 A1
(43) Pub. Date: May 26, 2011

(54) Double tipped head tweezers

(76) Inventor: Yong Hoon Cho, Fullerton, CA (US)

(21) Appl. No.: 12/592,209

(22) Filed: Nov. 20, 2009

(51) Int. Cl. B25B 9/02

(52) U.S. Cl. 294/99.2

(57) ABSTRACT

A tweezers formed from one or two elongated flat sheet. When they are formed from two elongated flat sheets, one end is joined together to form a stationary end resulting in a free opposing end opposite the stationary end. Each free opposing end has a head accommodating a plurality of tips at a distance from each other, the tips from the top member pairing with the tips from the bottom member, opening and closing according to a pressure exerted on a surface proximal to the free opposing ends. The tweezers formed from one flat elongated sheet having two opposite ends are folded at a mid section, the folded section forms the stationary end opposite a free opposing end formed from the two opposite ends of the elongated sheet.

This invention relates to a tweezers comprising a plurality of tips on the pincers or clamping mechanism, the tips having the same or a combination of different shapes for different purposes.

### BACKGROUND

Most tweezers only have one tip at the head of the pincer of the tweezers. The body is generally constructed from two elongated flat sheets or one elongated flat sheet. The two elongated flat sheets are joined together at one end to form the stationary end resulting in a pair of free opposing ends. The joining of the two elongated sheets at one end causes the opposite end, the free opposing ends, to open up or space apart, consequently, allowing movement at this end as pressure by the fingers for example, is exerted or released at the outside surfaces of the elongated flat sheets proximal to the free opposing end, hereinafter also referred to as free end. The free end is identified here as the pincer and is responsible for the clamping mechanism. For tweezers formed from one elongated flat sheet, the elongated flat sheet is usually folded, looped or bent at a mid position and the folded end forms the stationary end. Folding, looping and bending are collectively referred to herein as folding unless specifically stated. The resulting free ends are formed from the opposite ends of the original elongated flat sheet that are now made proximal and usually aligned to form a matching top and bottom tip after folding depending upon the type of tips desired.

The presence of multiple heads in one tweezers is desirable because there are different types or applications of tweezers, there are those for cosmetic purposes, usually for plucking unwanted hair, there are those used in surgery for holding or gripping tissues, blood vessels, organs and the like, there are those used in dentistry for clamping a tooth, there are those used in weaving and embroidery for plucking or inserting a thread, etc. In these applications, each tweezers has its own head. Head in this application is where the tips are on the pincer of the tweezers. With individual tweezers having only one type of tip, one has to carry or prepare each individual tweezers needed in an operation. Also occasions when only one tweezers with one head is at hand, one has to adjust and make do with what one has causing sub-optimal functions. Some tweezers recently in the market have two heads with their respective tips located at opposite ends of the tweezers, thereby requiring one to flip the tweezers to use the other tip which may either pose a risk of dropping the tweezers during the flipping process, more manipulation required in doing so and will also allow the other used end to snag or touch another surface while the other tip is being used causing injury or cross contamination if the used tip is dirty and contaminated.

It is therefore an object of this invention to provide a tweezers with one head on one end of the tweezers having two tips for variable purpose or function.

It is also an object of this invention to minimize the number of individual tweezers needed to carry on a desired function or operation.

It is a further object of this invention to provide a tweezers with a finger touching pad for better grip and comfortable handling.

It is still a further object of this invention to provide an opening at the stationary end of the tweezers that can be used to hang the tweezers when not in use.

### SUMMARY

A tweezers, comprising: a body having a top member and a bottom member formed from one or two elongated flat sheets. When they are formed from two elongated flat sheets, one end is joined together to form a stationary end resulting in a free opposing end opposite the stationary end. Each free opposing end has a head accommodating a plurality of tips at a distance from each other, the tips from the top member pairing with the tips from the bottom member, opening and closing according to a pressure exerted on an outside surface of the top and bottom member proximal to the free opposing ends.

The ends are joined together by fusion, screws, connectors, welding or staking. The tweezers formed from one flat elongated sheet having two opposite ends are folded at a mid section, the folded section forms the stationary end opposite a free opposing end formed from the two opposite ends of the elongated sheet.
The two opposite ends are aligned to form a matching top and bottom tip. The free opposing ends are designed similarly as those tweezers formed from two elongated sheets, they open and close in the same manner. The tips on the head are of one or the same or a combination of different shapes. It is recommended for the tips on one head to have complimentary functions. Materials that are resilient are good for making tweezers.

To accommodate a plurality of tips on the head, each head of the free opposing end is flared or widen up. The plurality of tips are positioned in the same or common plane. To use the multiple tips, thee tips are interchanged and accessed by moving left or right of the head. The tips are usually tapered inward from an outside surface of the head of the top and bottom members to allow the tips to close without the respective heads touching each other. Some tips require or function better with a flat area at its inner surface for a better grip. An opening can be bored at the stationary end of the tweezers to provide a means for hanging the tweezers on a hook, key chain, and the like. The top and bottom outside surface of top and bottom members may be padded for comfort or roughened for a better grip. The top and bottom surfaces of the top and bottom member can also be widened for a better grip.

Other embodiments of the present invention will become readily apparent to those skilled in the art from the following detailed description, wherein it shows and describes only certain embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Aspects of the present invention are illustrated by way of example, and not by way of limitation, in the accompanying drawings, wherein:

FIG. 1A is a perspective view of a tweezers formed from two flat elongated sheets having two tips on a head of a pincer.

FIG. 1B is a perspective view of a tweezers formed from one flat elongated sheet folded at a middle location having two tips on a head of a pincer.

FIG. 2 shows examples of tips having different shapes.

FIG. 3 is an exploded view on one example on how a pad attaches to the outside surface of the body of the tweezers.

FIGS. 4A and 4B shows the opening on the two different types of tweezers.

### DETAILED DESCRIPTION OF THE INVENTION

The detailed description represented herein is not intended to represent the only way or the only embodiment in which the claimed invention may be practiced. The description herein is provided merely as an example or examples or illustrations of the claimed invention and should not be construed as the only way or as preferred or advantageous over other embodiments or means of practicing the invention. Any tweezers with a head having multiple tips on one end of a tweezers is within the scope of this invention. The detailed description includes specific details to provide a thorough understanding of the claimed invention and it is apparent to those skilled in the art that the claimed invention may be practiced without these specific details. In some instances, well known structures and devices are shown in block diagrams or drawn with broken lines in order to either avoid obscuring the main concepts of the invention or to show the relationship of one part to the other.

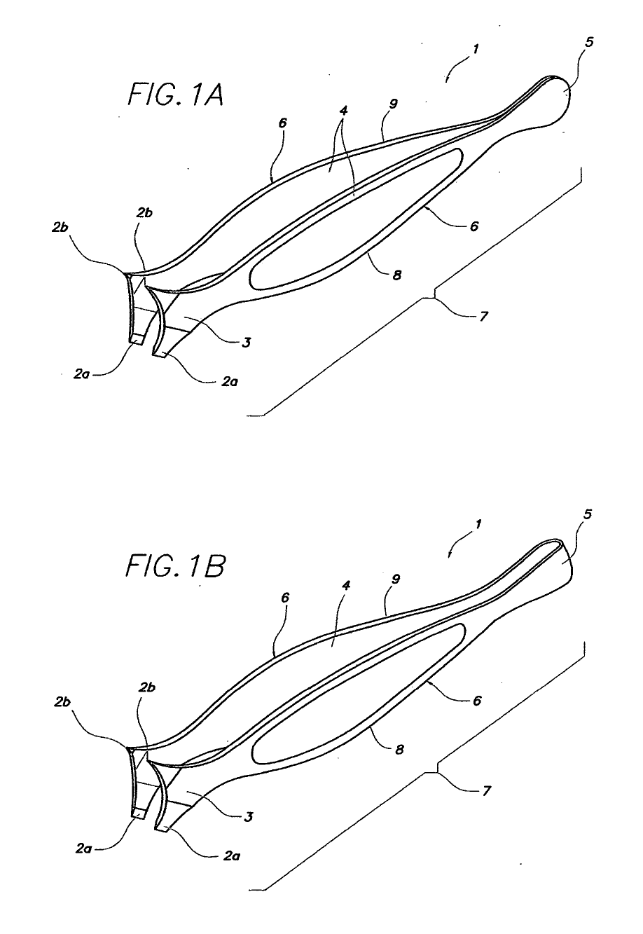

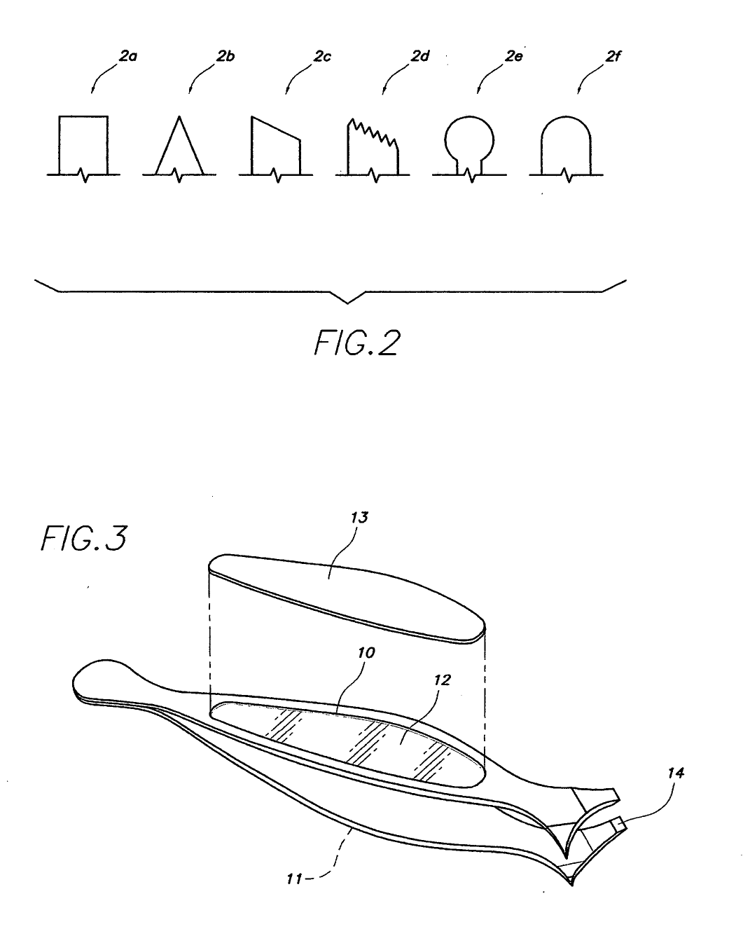

FIG. 1A is a perspective view of a tweezers 1 having two tips 2 on a single head 3 formed from two elongated flat sheets 4 joined at an end opposite the head 3. FIG. 1B is a perspective view of a tweezers 1 having two tips 2 on a single head 3 formed from one elongated flat sheet 4 folded midpoint to form a stationary end 5 and a free opposing ends 6. The free opposing ends 6 is identified here as the pincers and has the head 3 having at least two tips 2 of the tweezers 1. The pincers can have the tips 2 formed of any desired shape in accordance with the nature of the work to be done using the tweezers. In the claimed invention, it is recommended to have a combination of tips 2 with complimentary functions such as a square tip 2a for plucking hair from large areas of the face and a pointed tip 2b for precision shaping and plucking of short hair as shown in FIGS. 1A and 1B. It is to be noted that a slanted tip 2c may be combined with either the square or pointed tip. Likewise, any tip of any shape, for example, those shown in FIG. 2 may be combined with each other or with any of the pointed, slanted or square tip. FIG. 2 shows some examples of the tweezer tips. For surgical purpose, the opposing tips may comprise tips that are straight, curved, serrated, toothed, ring shape, etc. Other tips for other purposes not shown here are known. Other fields of discipline such as dentistry may require the same or other specialized tips. The pincers 6 and the tips 2 may be designed in various sizes depending on the intended use of the tweezers.

A simple way of manufacturing a tweezers with a joined stationary end 5 is to take two flat elongated sheets 4 of a desired length; cut these units to form a body 7 of the tweezers according to the desired shape of the tweezers 1; shape the tips 2 of the head 3 of the pincers 6 to the desired form; and join the two elongated sheets one end. Joining only one end of the tweezers will form a free opposing end 6 at the other end of the tweezers. The tweezers are joined together for example by fusion, welding or by staking. Other means of joining the two flat sheets are acceptable so long as the two elongated units are kept connected with each other, for example, the two elongated units forming the body of the tweezers can also be joined by screws or other known connectors (not shown).

Tweezers from one elongated flat sheet is simply looped, bent or folded, at a mid location to form the stationary end. The two opposite ends of the single elongated sheet becomes the head of the top and bottom member of the resulting body of the tweezers after it is folded which correspond to the free opposing end of the tweezer. The heads of the free opposing ends are aligned, closely aligned or matching to facilitate the forming or carving of a matching or paired top and bottom tip.

Materials that are currently used to make tweezers can be used for this claimed invention such as metal or metal alloys like stainless steel, titanium, chromium and others. Plastics have also been used for manufacturing tweezers. A required characteristic is to have resiliency on the pincers in order to manually operate the pincers between an open (releasing the object) and closed position (clamping the object). A user grasps the body of the tweezers anywhere along the longitudinal axis of the pincers and the pressure exerted on the tips will depend upon the distance of the tips from the source of the pressure.

Current tweezers have a variety of shapes, some have curved the flat elongated sheets forming the body 7, some just have it straight. The distance between the top 8 and bottom 9 members of the body between the joined end and the opposing free ends can be at an angle from each other or they may be at an angle near the joined end before gradually or abruptly curving, then converging near the head 3. For the latter, the flat elongated sheets are curved accordingly. Also, the body can be formed with the top member, straight and the bottom member curved or vice-versa. Likewise, the flat elongated sheet can be curved at certain portions of the body to provide more distance between the top and bottom members of the body of the tweezers proximal to the pincers. The corresponding distance between the top and bottom member on tweezers formed from one elongated flat sheet is dictated by the way the stationary end is formed, for example, a fold will result into a different distance than one that is looped or bent. The shape of the outside top 10 or bottom 11 surface of the body can also be of different shape such as circular, oval, oblong and other shapes limited only by ones imagination. The main purpose is to provide more room for the fingers as they press on the body to operate the pincers thereby allowing the fingers to exert more pressure without hurting the fingers. The wider outside surfaces 10 and 11 and the greater distance between the top 8 and bottom 9 members of the body generally provide a better grip during the use of the tweezers. The top 10 and bottom outside surface 11 of the body of the tweezers can also be padded as disclosed in U.S. Pat. No. 6,866,314B2 issued to the same inventor or a portion of the outside surfaces 10 and/or 11 of the body 7 may be roughened or etched out to form a flat recessed surface 12 where a soft or rough surfaced pad 13 with a shape or contour matching the contour or shape of the recessed surface 12 can be attached to, for example by glue or adhesive as shown in FIG. 3. Alternately, the soft or rough surfaced pad 13 can simply be adhered to the outside surface of the body of the tweezers without the need of etching out a flat recessed surface. The padded surface provides comfort to the fingers while the roughened surface provides a better grip, consequently, a padded or soft roughened surface is recommended. The bottom outside surfaces of the bottom member opposite the respective top outside surfaces of the top member of the body can be shaped the same or differently than the top outside surface of the top member. A curved shaped body 7 can also offer a more aesthetic impression.

The pincers 6 is at one end of the body 7, at the end opposite the stationary end. Since there are two opposing ends on the pincer, each opposing end has a head accommodating a tip. The tip from the top member 8 is paired with the tip of the bottom member 9. The surface of the head 3 on the pincers 6 flares or widen up to accommodate the number of tips 2. In these tweezers, there are more than one tip on each head. A tweezers with two tips on one head is used to illustrate this. FIGS. 1A and 1B show how the head on the pincers flare to accommodate two tips. The degree or amount of flare varies depending upon the space desired between the two tips. A spacing of about 2 mm. between the edges of the respective bases of the two tips adjacent to each other is sufficient to separate one tip from the other and to easily manipulate the tweezers. The tips are usually positioned in the same or common plane for easy access. Also, the tips from the respective head of the top and bottom members are usually tapered inward from the outside surface of the head to allow the tips to close without the respective heads touching each other. Some tips are designed to have a flat area 14 at its inner surface where the tips touch each other for better grip.

With two different tips on the same head of the tweezers, one can interchange the tips or use one tip and after its use, simply move left or right of the head to access the other tip. For example, one can pluck the hair with the square tip 2a at an area above or below the eyebrows, and then simply move the head of the tweezers to pluck the short hair or those on the borders to shape the eyebrows with the pointed tip 2b without putting one tweezer aside and looking for the other tweezer or flipping the tweezers. On the latter, the tips being closed to each other offers the advantage of not needing to flip the tweezers to access another tip located opposite the first tip as found in other tweezers. When the tips are on opposite ends of the tweezers the other tip away from the fingers of the user may be exposed to touching another surface which can contaminate that tip unless washed before use and this is especially true on tweezers used for medical and dental procedures needing asceptic or sterile conditions. Likewise, the tip may catch or snag into something during the flipping operation.

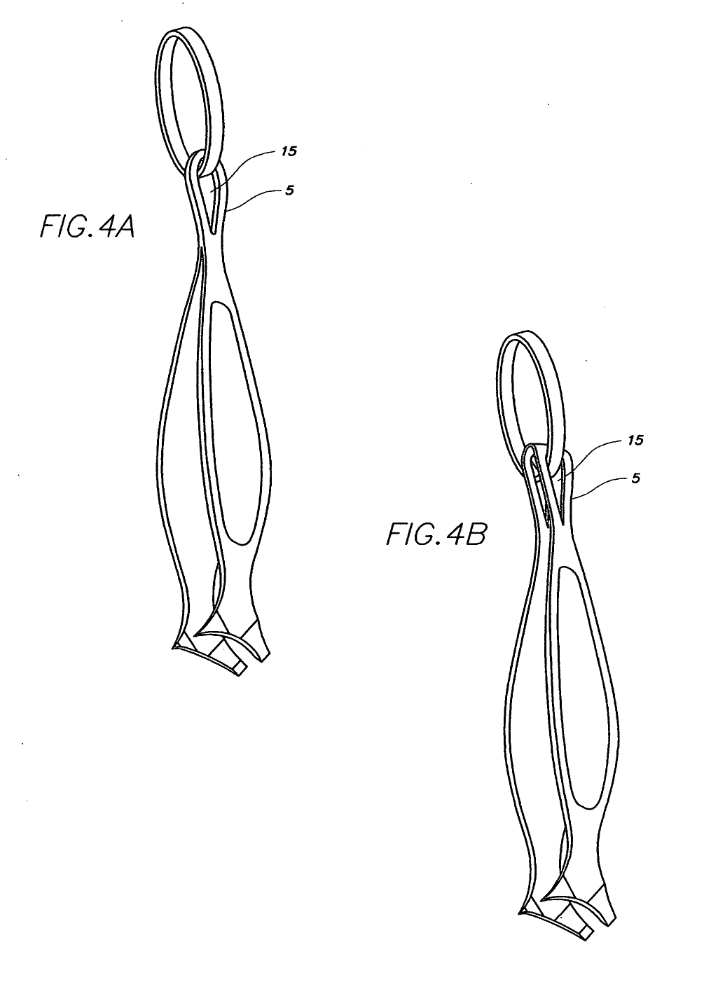

An opening 15 may be bored or etched out at the stationary end of the tweezers as shown in FIGS. 4A and 4B. This opening can be used to hang the tweezers on a hook, keychain or other similar purpose devices when not in use.

While the embodiments of the present invention have been described, it should be understood that various changes, adaptations, and modifications may be made therein without departing from the spirit of the invention and the scope of the claims.

I claim:

1. A tweezers, comprising: a body having a top member and a bottom member formed from two elongated flat sheet joined together on one end to form a stationary end and a free opposing end opposite the stationary end, each free opposing end having a head accommodating a plurality of tips at a distance from each other, the tips from the top member pairing with the tips from the bottom member, opening and closing according to a pressure exerted on an outside surface of the top and bottom member proximal to the free opposing ends.

2. The tweezers of claim 1 wherein the tips on the head are of one shape.

3. The tweezers of claim 1 wherein the tips are a combination of different shapes.

4. The tweezers of claim 3 wherein the combination of tips on the head have complimentary functions.

5. The tweezers of claim 1 wherein one end is joined by fusion, screws, connectors, welding or staking.

6. The tweezers of claim 1 wherein the elongated flat sheets are made of resilient material.

7. The tweezers of claim 1 wherein each head of the free opposing end flares or widen up to accommodate the plurality of tips.

8. The tweezers of claim 1 wherein each head of the free opposing end flares or widen up to accommodate two tips.

9. The tweezers of claim 1 wherein the plurality of tips are positioned in the same or common plane.

10. The tweezers of claim 9 wherein the tips are interchanged by moving left or right of the head.

11. The tweezers of claim 1 wherein the tips from the head of the top and bottom members are tapered inward from an outside surface of the head to allow the tips to close without the respective heads touching each other.

12. The tweezers of claim 1 further comprising a flat area at an inner surface of the tips of the top and bottom members for better grip.

13. The tweezers of claim 1 further comprising an opening bored or etched out at the stationary end of the tweezers.

14. A tweezers, comprising: a body having a top and bottom member formed from one flat elongated sheet having two opposite ends folded at a mid section, the folded section forming a stationary end opposite a free opposing end formed from the two opposite ends, each free opposing end having a head accommodating a plurality of tips at a distance from each other, the tips from the top member pairing with the tips from the bottom member, opening and closing according to a pressure exerted on an outside surface of the top and bottom member proximal to the free opposing ends.

15. The tweezers of claim 14 wherein the two opposite ends are aligned to form a matching top and bottom tip.

16. A tweezers, comprising: a body having a top member and a bottom member with a top and bottom outside surface forming a stationary end and a free opposing end opposite the stationary end, the free opposing end performing the clamping mechanism, each free opposing end having a flared head accommodating a plurality of tips at a distance from each other, the tips from the top member pairing with the tips from the bottom member, opening and closing according to a pressure exerted on the outside surface of the top and bottom member proximal to the free opposing ends, the top and bottom outside surface having a pad or roughened for better grip.

17. The tweezers of claim 16 further comprising an opening at the stationary end for hanging the tweezers.

18. The tweezers of claim 16 wherein the top and bottom surfaces are widened.

19. The tweezers of claim 16 wherein the tips on the head are of same or a combination of different shapes.

20. The tweezers of claim 16 wherein the stationary end is formed by folding or fusion.
